(19) United States
(12) Patent Application Publication
(10) Pub. No.: US 2011/0016733 A1
(43) Pub. Date: Jan. 27, 2011

(54) CANISTER RECYCLING TOOL

(76) Inventor: John D. Peretti, Manchester, NH (US)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/840,836

(22) Filed: Jul. 21, 2010

Related U.S. Application Data
(60) Provisional application No. 61/227,313, filed on Jul. 21, 2009.

(51) Int. Cl. B26F 1/32

(52) U.S. Cl. 30/361; 83/745

(57) ABSTRACT

In one embodiment, a tool that is useful for purging pressurized canisters of their contents such as for preparing such canisters for post-processing, e.g., recycling. The tool comprises a tool body and a canister interface with a joint that permits the tool body to rotate about the canister interface. The tool can also comprise a marking implement that is secured to the tool body, and which implement is configured to mark the surface of the canister such as to mark the surface when the canister is depleted of its contents. In one example, the marking implement comprises a marking point shaped and constructed so as to puncture the surface of the canister in a manner that exposes the interior of the canister to the environment.

### CROSS-REFERENCE TO RELATED APPLICATIONS

This application claims the benefit of priority under 35 U.S.C. §119(e) from U.S. Provisional Patent Application Serial No. 61/227,313, entitled “Canister Recycling Tool” and filed on Jul. 21, 2009. The content of this application is incorporated herein by reference in its entirety.

### TECHNICAL FIELD

The subject matter relates to tools for preparing pressurized canisters for recycling, and more particularly in one embodiment to a tool that is configured to evacuate the contents via a relief valve on the pressurized canister and to perforate the wall of the pressurized canister.

### BACKGROUND

Many canisters that are used for cooking devices, e.g., gas stoves, are constructed of materials, which are of the type that can be effectively processed, and recycled for secondary life. Such canisters may contain, for example, metals (e.g., steel, aluminum), as well as plastics made of polymers (and other composition), and composites with chemical structures that are consistent with recyclable material. When handling containers that hold pressurized combustible liquids and gasses, however, caution is required to avoid mixing canisters with contents under pressure with the other, processable materials at the recycling center.

To prevent these pressurized containers from being mixed with “recycle-ready” canisters, it is necessary to de-pressurize the container. Depressurization is often effectuate by actuating a valve, which releases the contents of the canister. The depressurized container is then marked in a manner that indicates that the container is empty, and ready to be recycled with the other recyclable material.

Therefore, there is a need for a device that can interface with the canister in a manner that permits the canister to be depressurized, and that also provides an implement for marking the container as being “recycle-ready.” It is likewise desirable that the implement is constructed in such a manner that it provides a permanent demarcation on the canister. That is, by providing a permanent mark on the canister, it reduces the likelihood that a canister with combustible contents that is still under pressure is mixed with other materials that are ready to be recycled.

### SUMMARY

Embodiments of a tool are provided that attach to a pressurized canister so as to permit evacuation of the pressurized fluid therein. The point of attachment further serves as a fulcrum, about which portions of the tool can rotate to effectuate marking of the canister. Such markings include perforations or holes that expose the interior of the canister to the atmosphere, thereby providing a visual aid to identify the canister as ready for recycling.

Further discussion of these and other features is provided below in connection with one or more embodiments, examples of which may be described in the following:

In one embodiment, a tool for depressurizing a canister filled with a fluid. The tool comprises a canister interface comprising a valve actuator for evacuating the fluid from the canister and a pivot coupled to the canister interface. The tool also comprises a tool body secured to the pivot and a marking implement coupled to the tool body and spaced apart from the pivot. In one example of the tool, the pivot permits relative movement between the tool body and the canister interface. In another example of the tool, the marking implement is configured to pierce a wall of the canister.

In another embodiment, an implement for marking a canister having contents under pressure. The implement comprises means for engaging a valve of the canister, means for actuating the valve, means for deforming a wall of the canister, and means for pivoting the deforming means relative to the engaging means.

In yet another embodiment, a device for preparing a pressurized canister for recycling. The device comprises a tool body comprising a pivot and a marking implement spaced apart from the pivot. The device also comprises a cylindrical body coupled to the pivot, the cylindrical body having a inner cavity with an engagement area for engaging a relief valve on the pressurized canister. The device further comprises a valve actuator disposed in the inner cavity. In one example of the device, the pivot and the marking implement are formed integrally with the tool body. In another example of the device, the cylindrical body rotates about an axis formed by the pivot. In yet another example of the device, the marking implement is configured to pierce a wall of the pressurized canister.

### BRIEF DESCRIPTION OF THE DRAWINGS

So that the manner in which the above recited features of the present invention can be understood in detail, a more particular description of the invention briefly summarized above, may be had by reference to the figures, some of which are illustrated and described in the accompanying appendix. It is to be noted, however, that the appended documents illustrate only typical embodiments of this invention and are therefore not to be considered limiting of its scope, for the invention may admit to other equally effective embodiments. Moreover, any drawings are not necessarily to scale, emphasis generally being placed upon illustrating the principles of certain embodiments of invention.

Thus, for further understanding of the nature and objects of the invention, references can be made to the following detailed description, read in connection with the drawings in which:

FIG. 1 is a side, plan view of an exemplary embodiment of a canister recycling tool disposed on a canister in one operating condition;

FIG. 2 is a side, plan view of the canister recycling tool of FIG. 1 in another operating condition;

FIG. 3 is a perspective, top view of another exemplary embodiment of a canister recycling tool;

FIG. 4 is a top, plan view of the canister recycling tool of FIG. 3;

FIG. 5 is a side, plan view of the canister recycling tool of FIG. 3;

FIG. 6 is a front, cross-section view of the canister recycling tool in FIG. 5; and

FIG. 7 is a perspective, bottom view of yet another exemplary embodiment of a canister recycling tool.

### DETAILED DESCRIPTION

With reference to the drawings in general and broadly stated, there is provided a device that is useful to depressurize a canister filled with fluid under pressure and to mark the canister with a permanent demarcation so as to indicate that the canister is empty. As discussed in the examples provided below, the device can comprise a tool that engages a portion of the canister, and in one embodiment the tool is configured to engage a valve, valve stem, or other portion of the canister through which the interior contents of the canister can be exposed to the environment. By way of this engagement, the tool provides a path for evacuation of the contents of the canister from its pressurized confinement inside of the canister. This engagement also secures the tool to the canister in a manner that permits a portion of the tool to move (e.g., by rotation about the secured location) and effectuate the demarcation of the canister.

The duality of the configuration of the tool is beneficial because embodiments of the tool provide an end user with a single tool that can readily evacuate and mark the canister. These functions are performed without removing the tool from its position of engagement with the valve and/or the canister. Moreover, the inventors have developed a mechanism that, when the tool is employed, can prevent accidents such as those in which the end user mistakenly punctures a canister in which fluid is still under pressure, thereby causing violent exhausting of the pressurized fluids, including flammable and/or hazardous fluids, in close proximity to the end user.

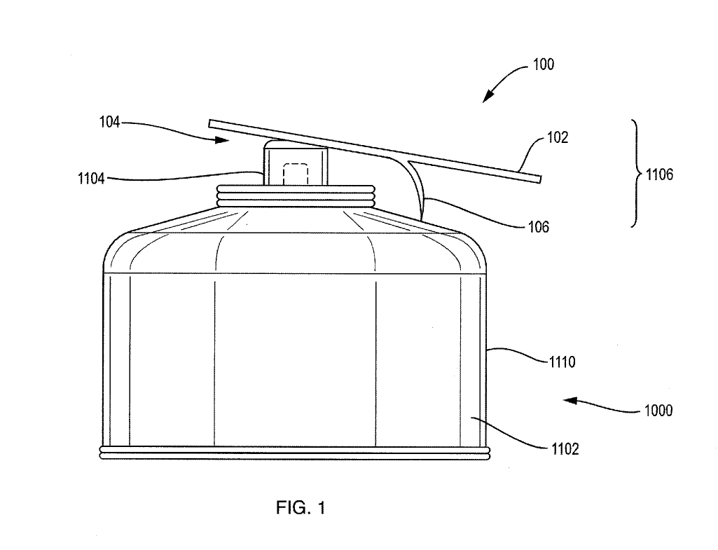

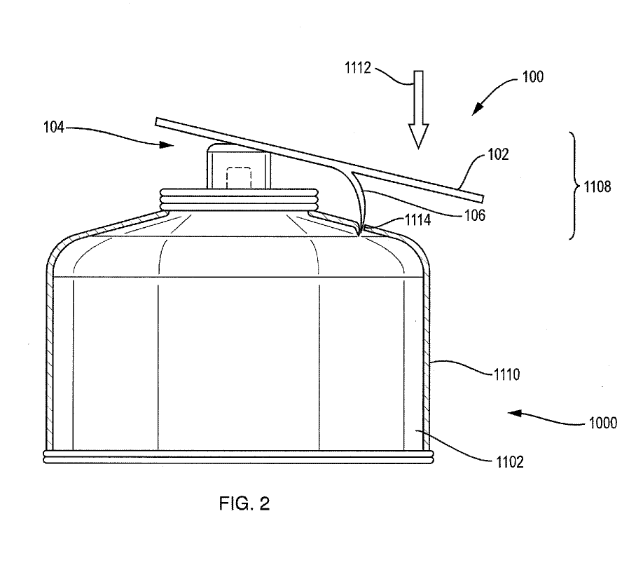

For further details and instruction as to tools with these and other feature, reference can now be had to FIGS. 1 and 2 in which an exemplary embodiment of a tool 100 is illustrated. In the present example, the tool 100 comprises a tool body 102 that includes a canister interface 104 and a marking implement 106. Both are coupled to the tool body 102 such as by way of fasteners and/or integral construction. The tool 100 is shown coupled to a canister 1000 such as a pressurized canister 1102 with a fluid disposed under pressure therein. Fluids can include flammable propellants (e.g., propane and butane) and other hazardous materials. The pressurized canister 1102 can have a relief valve, generally identified by the numeral 1104, and onto which is secured the canister interface 104.

The tool 100 can operate in one or more operating conditions. By way of example, but not limitation, the operating conditions can include a depressurizing condition 1106 (FIG. 1) and a marking condition 1108 (FIG. 2), which causes a marking on and/or through a wall 1110 of the canister 1000. The depressurizing condition 1106 occurs generally when the tool 100 is coupled to the canister 1000 such as by securing the canister interface 104 to the relief valve 1104. This coupling can actuate the relief valve 1104 thereby exposing the contents of the canister 1000 to atmospheric pressure. This exposure causes the fluid to evacuate from the interior of the canister 1000. In one example, the canister interface 104 is configured to actuate the relief valve 1104 upon implementation of the tool 100 on the canister 1000. In another example, one or more of the tool 100 and the canister interface 104 include actuatable components, which are activated by an end user to open the relief valve 1104, e.g., after the canister interface 104 is secured to the relief valve 1104.

In one embodiment, the marking condition 1108 results from application of a force vector 1112 to the tool body 102. The force vector 1112 causes the marking implement 106 to engage the wall 1110. This engagement can impress or otherwise secure in the wall 1110 a mark 1114, which indicates in one example that the canister 1000 is devoid or substantially devoid of fluid. In one embodiment, the marking implement 106 is configured to cause deformation to a portion of the wall 1110. This deformation includes permanent deformations such as deformation effectuated by configurations of the marking implement 106 that can puncture, pierce, and/or perforate the wall 1110. Permanent deformation is somewhat desirable, but not necessary, because markings that puncture the wall 1110 can render the canister 1000 unfit for pressurization as the interior contents and volume of the canister 1000 is exposed to the atmosphere via the mark 1114.

Force and pressure, as generally indicated by the force vector 1112, can be applied variously on and/or about and/or to the tool body 102 as desired. Application of the force vector 1112 can be enhanced such as by way of the layout and spacing between the canister interface 104 and the marking implement 106. In one embodiment, the tool body 102 is configured to pivot about the canister interface 104. This pivoting can accentuate the effectiveness of the force vector 1112, wherein the tool body 102 acts as a lever that is secured at the canister interface 104. Force such as force (or pressure) imparted by the hand of the end user hand or a tool (e.g., a hammer) is directed generally downwardly onto the tool body 102. In one example, the force vector 1112 is preferably directed proximate the marking implement 106, with the spacing between the marking implement 106 and the canister interface 104 being selected to optimize the amount of the force vector 1112 required to puncture the wall 1110 of the canister 1000.

Materials generally preferred for construction of the tool 100 include, for example, metals, plastics, composites, and combinations and derivations thereof. These materials can be used as portions of the tool body 102, the canister interface 104, and the marking implement 106. Exemplary materials include, but are not limited to, aluminum, steel and stainless steel, and brass, among many others. Resilient materials such as rubber and related polymeric materials can be included to provide protective and ergonomic coverings such as coverings compatible with the hand of the end user. Paint, powder coats, and plating (e.g., anodized hard coatings) can also be used to prevent corrosion and related damage.

Exemplary components of the tool 100 are compatible with various manufacturing processes such as casting, molding, extruding, and machining (e.g., turning, and milling). Each of these techniques may be suitable for forming, e.g., the tool body 102, the canister interface 104, and the marking implement 106 as described herein. Because these processes, and the materials that are utilized by such processes, are generally well-known to those having ordinary skill in the tool and tooling art, no additional details will be provided herein, unless such details are necessary to explain the embodiments and concepts of the present disclosure.

When implemented such as to evacuate and prepare the canister 1000 for recycling, the end user secures the canister interface 104 to the relief valve 1104. Depending on the configuration of the relief valve 1104, and correspondingly to the construction of the canister interface 104, the end user may twist the canister interface 104 onto the canister 1000. This twisting can engage screw threads or other locking features that require rotation of one or both of the canister interface 104 and the canister 1000. Evacuation of the fluid and depressurization of the canister 1000 can occur variously. Certain embodiments of the tool 100 are configured for immediate engagement of the relief valve 1104. In one example, the relief valve 1104 is opened upon initial engagement of the canister interface 104, with the flow through the relief valve 1104 increasing with further engagement of, e.g., the screw threads. In one embodiment, the canister interface 104 must fully engage the relief valve 1104 to permit fluid to flow out of the canister 1000. In another embodiment, the end user executes a secondary operation to actuate the relief valve 1104, such secondary operation being performed in one example after the canister interface 104 is secured to the relief valve 1104.

Having evacuated the fluid from the canister 1000, as indicated in one example by the lack of audible noise indicative of pressurized fluid exiting via the relief valve 1104, the end user can utilize the marking implement 106. As discussed above, the end user can apply a force such by pressing on the tool body 102, thereby causing the marking implement 106 to pierce through the wall 1110 of the canister 1000. Marking can be done in one place, or in alternative implementations of the tool 100 the marking is done in a variety of places, e.g., circumferentially about the relief valve 1104.

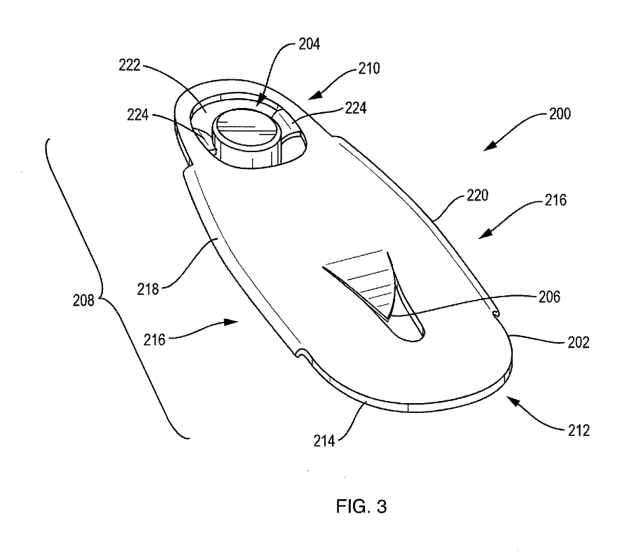

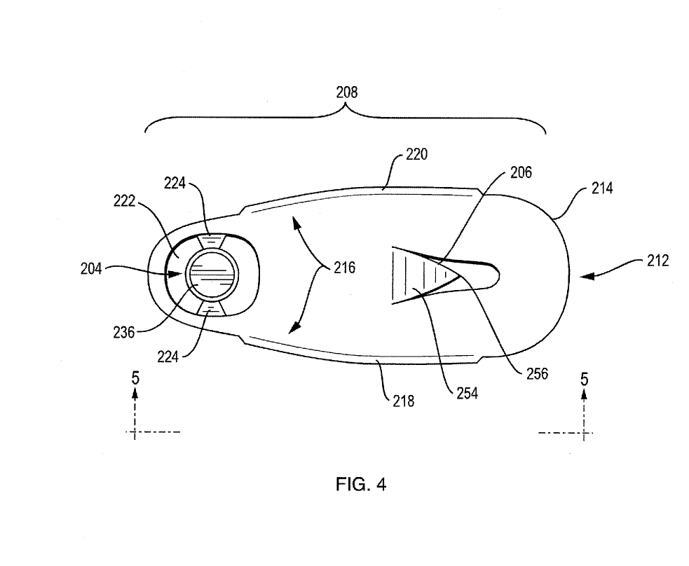

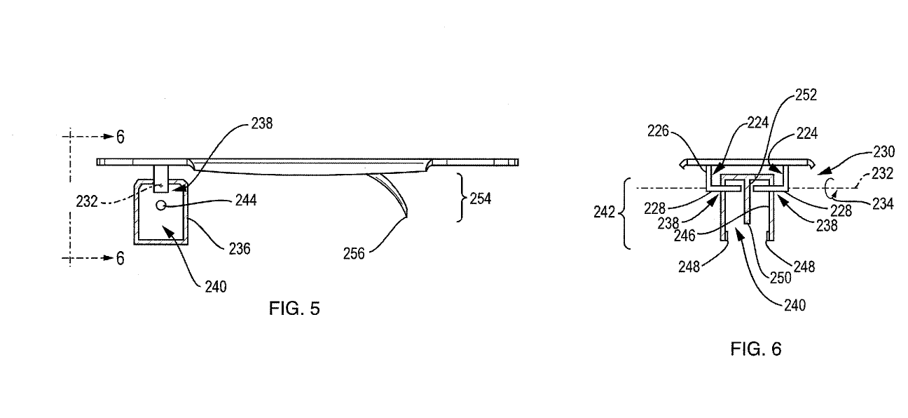

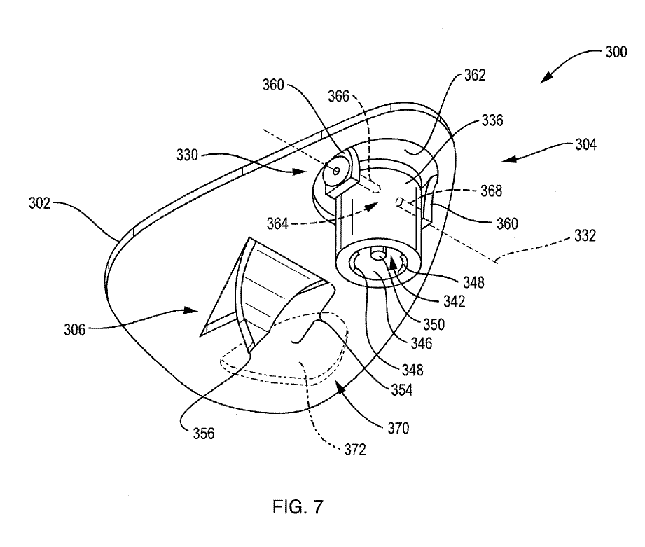

Referring back to the drawings, and more particularly to FIGS. 3-7, there is provided other exemplary embodiments of a tool 200 and 300 Like numerals are used to identify like components as between the FIGS. 1 and 2 and 3-7, except the numerals are increased (e.g., 100 is 200 in FIGS. 3-6 and 100 is 300 in FIG. 7). Focusing the discussion first on the tool 200, there is shown that the tool 200 comprises a tool body 202 with a canister interface 204 and a marking implement 206. Noted is that features and concepts such as those discussed in connection with tool 100 are compatible with the tool 200 and 300 discussed below. Thus while some or all of these concepts may not be discussed in connection with the tool 200 and 300, each of these concepts may be generally incorporated in whole or in part into embodiments of the tool 200 and 300 within the scope and spirit of the present disclosure.

The tool body 202 comprises an outer peripheral profile 208 with an attachment end 210 and a free end 212 having, respectively, the canister interface 204 and the marking implement 206 proximate thereto. The tool body 202 also comprises an outer edge 214 that defines the shape of the tool body 202. The outer edge 214 includes one or more gripping portions 216 such as a first gripping portion 218 and a second gripping portion 220 being generally configured with rounded and/or softened corners. Near the attachment end 210, the tool body 202 comprises an opening 222 through the material of the tool body 202 and configured with a pair of fingers 224. As best depicted in FIG. 6, each of the fingers 224 comprise a vertical leg 226, extending away from the tool body 202, and a horizontal leg 228 that extends from the vertical leg 226 towards the horizontal leg 228 of the opposite finger 224. This configuration of the fingers 224 forms a joint 230 to which is coupled the canister interface 204, and in one construction the joint 230 forms an axis 232 for rotation 234 about which the tool body 202 can rotate when the canister interface 204 is secured to the relief valve 1104 (FIG. 1).

In one embodiment, the canister interface 204 is formed as a cylindrical body 236 with mounting holes 238 for receiving the horizontal leg 228 of each of the fingers 224. The cylindrical body 236 can also have an inner cavity 240 such as a bore 242 and one or more apertures 244 extending through the cylindrical body 236 to the bore 242. In one example, the bore 242 includes an inner surface 246, which can include an engagement area 248. The engagement area 248 can include threads, slots, pins, and other elements that facilitate engagement between the canister interface 204 and the relief valve 1104 (FIG. 1).

The canister interface 204 also comprises a valve actuator 250, depicted as a pin element 252 that is disposed in the bore 242. The pin element 252 can interact with the relief valve 1104 (FIG. 1) of the canister 1000 (FIG. 1). The pin element 252 and/or the valve actuator 250 is sized, shaped, and configured with features that are both complimentary to the construction of the relief valve 1104 (FIG. 1) and also that can engage the relief valve 1104 (FIG. 1) when the canister interface 204 is secured thereon.

The marking implement 206 comprises a body 254 with a marking point 256 located at one end of the body 254. The marking implement 206 can be constructed monolithically with the tool body 202 such as if the material of the tool body 202 is punched, pressed, and/or cut by laser or water jet. The marking implement 206 can also be constructed of individual pieces, which can be assembled to form a particular portion of the tool 200, or which are attached to such portion of the tool body 202. The marking point 256 can be configured to engage the wall 1110 (FIG. 1) of the canister 1000 (FIG. 1), and in one construction the marking point 256 is configured to deform the wall 1110 (FIG. 1) when a force is applied to the tool 200. Exemplary material for use as the marking point 256 include, but are not limited to, metals (e.g., steel), as well as plastics, composites, and other materials and combinations of materials with material properties (e.g., hardness and/or tensile strength) that are consistent with deflecting, deforming, and/or puncturing the wall 1110 (FIG. 1) of the canister 1000 (FIG. 1).

The tool 200 can be constructed variously, and in one construction various pieces are assembled together using techniques recognized in the art. By way of example, the tool body 202 can be formed from a sheet of material such as aluminum and stainless steel. Holes and openings can be cut, with tabs near the attachment end 210 provided so as to form the fingers 224. Secondary processing is useful to bend the fingers 224. Dies and related devices can be used to achieve the proper bending of the vertical legs 226 and the horizontal legs 228. The body 254 of the marking implement 206 can be formed by way of a die and/or press that provide the proper curvature, arcing, and general formation for the body 254. The marking point 256 can be formed as part of the body 254, and secondary processes can be used to treat the marking point 256 for hardness and other material properties that are necessary to deform the wall 1110 (FIG. 1) of the canister 1000 (FIG. 1).

Referring now to FIG. 7 and the embodiment of the tool 300, it is shown that the tool 300 comprises a tool body 302 that includes a canister interface 304 and a marking implement 306. The canister interface 304 comprises a joint 330 forming an axis 332, on which rotates a cylindrical body 336 that is useful to secure the tool 300 to the relief valve 1104 (FIG. 1). The cylindrical body 336 comprises a bore 342 with an inner surface 346, an engagement area 348, and a valve actuator 350. The marking implement 306 is also depicted, wherein the marking implement 306 comprises a body 354 on which is disposed a marking point 356. Each of these components may operate in a manner similar to and discussed in connection with one or more of the embodiments herein.

Continuing with the discussion of the tool 300, the joint 330 in the present example secures the canister interface 304 to the tool body 302. The joint 330 comprises a pair of mounting elements 360 that form an opening 362 for receiving the cylindrical body 336. A shaft 364 can be used to secure the cylindrical body 336 in position and provide the axis 332. The shaft 364 can extend to each of the mounting elements 360, or in one example the shaft 364 comprises a first shaft 366 and a second shaft 368.

The tool body 302 also comprises a tooling area 370, which can include an opening 372. The tooling area 370 can have a variety of shapes, sizes, and features. For example, the tooling area 370 and/or the opening 372, as well as other portions of the tool body 302, can be configured as, for example, as a bottle opener, a tool (e.g., a screwdriver), a knife or cutting blade, among many, many others.

Joints of the type used as joint 330 generally provide a pivot, which can permit the tool body 302 to rotate about the canister interface 304 such as when the canister interface 304 is in place on the canister (e.g., the canister 1000 (FIG. 1)). Such joints can include a variety of mechanical components, including, bushings, pins, bearings, bearing materials, and any combinations thereof. While typically having one degree of freedom (i.e., one axis of rotation), it is also contemplated that suitable joints that can be implemented on tool 300, and the tool 100 and 200 discussed above, wherein such joints can have more than one degree of freedom.

As discussed above, the canister interface 304 is constructed so that it can interface with and be secured to a portion of the canister (e.g., the canister 1000 (FIG. 1)). In one embodiment, the canister interface 304, by way of one more of its constituent components, is a releasably securable structure that is compatible with a complementary portion of the relief valve 1104 (FIG. 1). The canister interface 304 can be constructed in such a manner that it is formable, fittable, and otherwise engageable with pressurized-type containers such as propane cylinders, propane tanks, and other pressurized devices.

In one embodiment, the canister interface 304, when secured to the canister 1000 (FIG. 1), positions the valve actuator 350 at a position relative to, e.g., the valve on the canister. The valve actuator 344 is configured to engage the relief valve 1104 (Fig .1) in a manner that causes that exposes the interior pressurized portion of the canister 1000 (FIG. 1) to the atmosphere, or other environment with lower pressure than the interior of the canister 1000 (FIG. 1). The change in pressure causes the contents in the canister to evacuate, and in one particular constructions of the tool 300 the implementation of the valve actuator 344 permits substantially the entire contents of the canister to be evacuated. In one example, the canister 1000 (FIG. 1) is effectively devoid of its contents as a result of the implementation of the tool 300.

In view of the foregoing, there is described embodiments of tool 100, 200, and 300 (collectively, “the tools”) that are useful to evacuate the contents of a pressurized canister. The tools are constructed to prevent unintended evacuation such as by providing features that first evacuate the canister and then mark the canister to identify that the canister is devoid of pressurized fluid. Various configurations of the tools have been described. The variations of the tools are, however, exemplary of the concepts that can be included within any one or more of the embodiments of the tools that are made within the scope and spirit of the present disclosure.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

While the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. A tool for depressurizing a canister filled with a fluid, said tool comprising:
a canister interface comprising a valve actuator for evacuating the fluid from the canister;
a pivot coupled to the canister interface;
a tool body secured to the pivot; and
a marking implement coupled to the tool body and spaced apart from the pivot,
wherein the pivot permits relative movement between the tool body and the canister interface, and
wherein the marking implement is configured to pierce a wall of the canister.

2. A tool according to claim 1 wherein the canister interface comprises a cylindrical body with a bore and one or more apertures formed in the cylindrical body and that communicates with the bore, and wherein the bore comprises an engagement area that is configured to engage a relief valve on the canister.

3. A tool according to claim 2 wherein the engagement area comprises a surface with threads.

4. A tool according to claim 1 wherein the marking implement comprises a marking point and a body, and wherein the body is formed integrally with a portion of the tool body.

5. A tool according to claim 4 wherein the marking point comprises a material with a hardness that is greater than the material of the canister.

6. A tool according to claim 1 wherein the marking implement is configured to puncture the wall of the canister.

7. A tool according to claim 1 wherein rotation of the tool body about the pivot changes a position of the marking implement relative to the canister interface.

8. A tool according to claim 1 wherein the pivot is formed integrally with the tool body.

9. A tool according to claim 8 wherein the pivot comprises a pair of fingers, and wherein the canister interface is coupled to each of the pair of fingers.

10. A tool according to claim 1 wherein the tool body comprises an outer edge that has one or more gripping portions, and wherein the one or more gripping portions are positioned on opposing sides of the tool body.

11. An implement for marking a canister having contents under pressure, said implement comprising:
means for engaging a valve of the canister;
means for actuating the valve;
means for deforming a wall of the canister; and
means for pivoting the deforming means relative to the engaging means.

12. An implement according to claim 11 wherein the deforming means comprises a means for puncturing the wall.

13. An implement according to claim 11 wherein the actuating means actuates the valve in response to engagement of the engaging means with the valve.

14. An implement according to claim 11 wherein the pivoting means is formed integrally with the deforming means.

15. An implement according to claim 11 further comprising means for transmitting a force to the deforming means, wherein the deforming means is configured to puncture the wall.

16. A device for preparing a pressurized canister for recycling, said device comprising:
a tool body comprising a pivot and a marking implement spaced apart from the pivot;
a cylindrical body coupled to the pivot, the cylindrical body having a inner cavity with an engagement area for engaging a relief valve on the pressurized canister; and
a valve actuator disposed in the inner cavity,
wherein the pivot and the marking implement are formed integrally with the tool body,
wherein the cylindrical body rotates about an axis formed by the pivot, and
wherein the marking implement is configured to pierce a wall of the pressurized canister.

17. A device according to claim 16 wherein the tool body further comprise one or more of a bottle opener, a cutting blade, and a screwdriver.

18. A device according to claim 16 wherein the marking implement comprises a marking point, and wherein spacing of the marking point from the axis is selected so that the marking point punctures the pressurized canister upon application of a force.

19. A device according to claim 16 wherein the valve actuator is positioned relative to the engagement area so implementation of the engagement area on the relief valve evacuates the pressurized canister.

20. A device according to claim 16 further comprising one or more gripping portions coupled to the tool body.
